(19) United States
(12) Patent Application Publication
(10) Pub. No.: US 2005/0134915 A1
(43) Pub. Date: Jun. 23, 2005

(54) Network printing system and printing control method thereof

(75) Inventor: Woo-Hwa Ha, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/011,375

(22) Filed: Dec. 15, 2004

(30) Foreign Application Priority Data
Dec. 19, 2003 (KR) 2003-93596

(51) Int. Cl. G06F 15/00

(52) U.S. Cl. 358/1.15; 358/1.16

(57) ABSTRACT

A network printing system and a printing control method thereof are provided. The network printing system includes a plurality of hosts for selecting a delay for print data and transmitting the selected information together with the print data; and a network printer having a printing unit, a storage unit for spooling and storing the print data that is received from one of the plurality of hosts, and a control unit for controlling the printing unit so that the print data having the delay from among the print data that are stored in the storage unit is printed after the print data input subsequently is first printed. Accordingly, the printing efficiency can be improved by controlling the printing work so that the print data having the delay is printed when a network printer is in an idle state and the urgent print data is first processed.

### PRIORITY

This application claims the benefit under 35 U.S.C. 119(a) of Korean Patent Application No. 2003-93596, filed Dec. 19, 2003, in the Korean Intellectual Property Office, the entire disclosure of which is hereby incorporated by reference.

### BACKGROUND OF THE INVENTION

1. Field of the Invention

The present invention relates to a network printing system and a printing control method thereof. More particularly, the present invention relates to a network printing system and a printing control method thereof which can improve printing efficiency by printing specific print data from among print data transmitted from a plurality of hosts when a network printer is in an idle state.

2. Description of the Related Art

Most printers can be shared and used by several computers through a network, typically using Internet Protocol (IP). Such printers, are called network printers and are connected to a plurality of computers through a Local Area Network (LAN), store print information transmitted from the respective computers in a storage medium, form an image based on the stored print information, and print the image onto a printing medium such as paper.

FIG. 1 is a view schematically illustrating a general network printing system. Referring to FIG. 1, the network printing system is provided with host computers 10, 20 and 30, a hub 40, and a network printer 50. Here, the respective host computers 10, 20 and 30 are connected to the network printer 50 through the hub 40. In this case, the network printer 50 is allocated with an IP address in the same manner as the respective host computers 10, 20 and 30. The respective host computer, after a printer driver is installed, sets a port of the printer driver to the IP address allocated to the network printer 50, and outputs a printout command to the set IP address. If the network printer 50 receives printout commands from the respective host computers 10, 20 and 30, it detects the IP addresses of the host computers 10, 20 and 30 that output the printout commands, and performs the printing operation according to the print information corresponding to the received printout commands.

In the network printing system as described above, if the plurality of computers simultaneously transmit the print data to the network printer 50, the network printer 50 sequentially performs the print job in a first-in first-out (FIFO) manner. However, although some print data requires immediate printing without delay, other print data does not require immediate printing. Thus, a user who needs to perform a print job immediately, has to wait until other print data input previously are all processed. This is inconvenient for the user.

### SUMMARY OF THE INVENTION

The present invention has been developed in order to solve the above drawbacks and other problems associated with the conventional arrangement. An aspect of the present invention is to provide a network printing system and a printing control method thereof which can improve printing efficiency by controlling the print job so that from among print data transmitted from a plurality of hosts, non-urgent print data is printed when a network printer is in an idle state and urgent print data is processed first.

In order to achieve the aspect of the present invention, there is provided a network printing system, according to an embodiment of the present invention, which comprises a plurality of hosts for selecting a delay for print data and transmitting the selected information together with the print data; and a network printer having a printing unit, a storage unit for spooling and storing the print data that is received from one of the plurality of hosts, and a control unit for controlling the printing unit so that the print data having the delay from among the print data that are stored in the storage unit is printed after the print data input subsequently is first printed.

The host includes a setting unit for setting a delay duration period with respect to the print data having the delay.

The network printer further includes a real-time clock unit for tracking the present time, and a deletion unit for deleting the print data having the delay that is stored in the storage unit if the present time reaches the delay duration period set by the setting unit.

The network printer further includes a checking unit for checking whether the printing unit is driven and whether the print data is stored in the storage unit. Here, it is preferable that the control unit controls the printing unit to print the print data having the delay if it is determined that the printing unit is in an idle state before the present time reaches the delay duration period and no other print data that is stored in the storage unit exists except for the print data having the delay.

In another aspect of the present invention, there is provided a printing control method for a network printing system in which a plurality of hosts are connected to a network printer, according to an embodiment of the present invention, which comprises the steps of (a) one of the plurality of hosts selecting a delay for print data and transmitting the selected information to the network printer together with the print data; (b) the network printer spooling and storing at least one of the received print data; and (c) controlling the printing so that the print data having the delay from among the print data that are stored in the step (b) is printed after the print data input subsequently is first printed.

The step (a) includes the step of (d) setting a delay duration period with respect to the print data having the delay.

The printing control method further includes the steps of (e) tracking the present time, and (f) deleting the print data having the delay that is stored in the step (b) if the present time counted in the step (e) reaches the delay duration period set in the step (d).

The printing control method further includes the step of (g) checking whether a printing unit is driven and whether the print data is stored in the step (b). The step (c) controls the printing unit to print the print data having the delay if it is determined that the printing unit is in an idle state before the present time reaches the delay duration period and no other stored print data exists except for the print data having the delay.

As described above, the network printing system according to an embodiment of the present invention can improve the printing efficiency by processing the print data having the delay last and processing the urgent print data first.

### BRIEF DESCRIPTION OF THE DRAWINGS

The above aspects and features of the present invention will be more apparent by describing certain embodiments of the present invention with reference to the accompanying drawings, in which:

FIG. 1 is a view schematically illustrating a conventional network printing system;

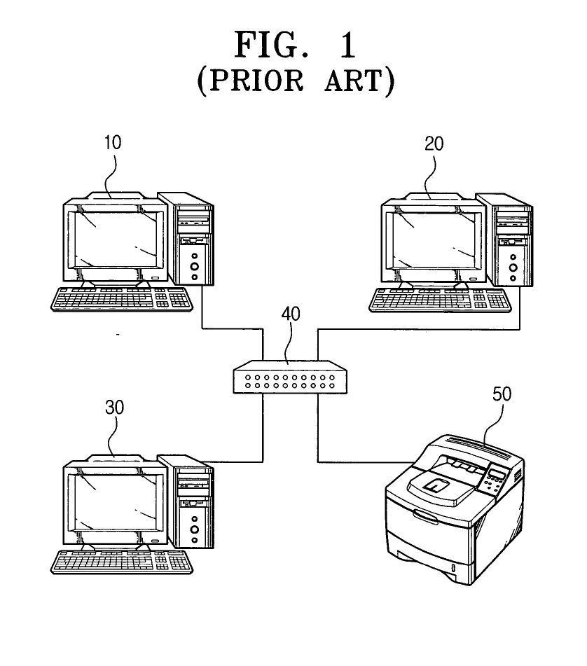

FIG. 2 is a block diagram illustrating the construction of a network printing system according to an embodiment of the present invention; and

FIG. 3 is a flowchart illustrating a printing control method for the network printing system of FIG. 2.

Throughout the drawings, it should be understood that the same or similar elements, features and structures are denoted by like reference numerals.

### DETAILED DESCRIPTION OF EXEMPLARY EMBODIMENTS

Certain embodiments of the present invention will be described in greater detail with reference to the accompanying drawings.

In the following description, the same drawing reference numerals are used for the same elements throughout the drawings. The matters defined in the description such as a detailed construction and elements are exemplary. Thus, it should be apparent that the present invention can be performed with various changes, made to the examples described herein. Also, descriptions of well-known functions or constructions are omitted for conciseness.

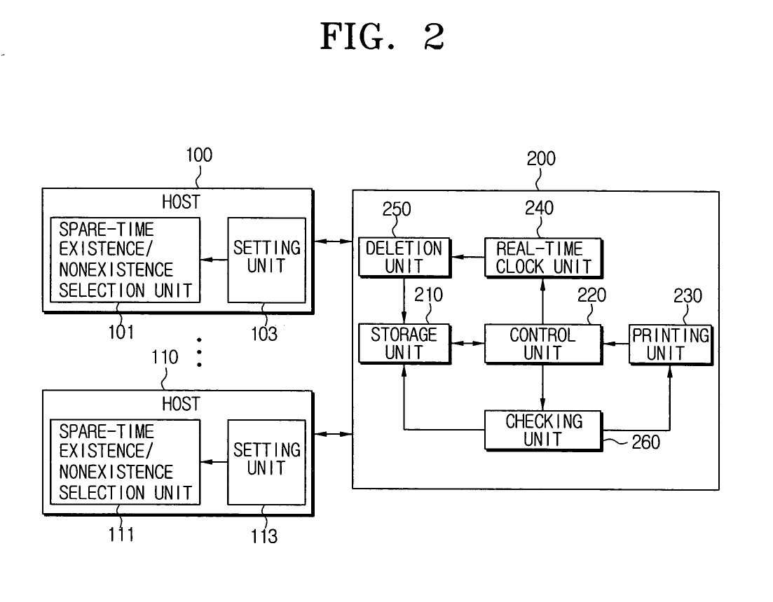

FIG. 2 is a block diagram illustrating the construction of a network printing system according to an embodiment of the present invention. Referring to FIG. 2, a network printer 200 is connected to a plurality of hosts 100 and 110. Here, the hosts 100 and 110 are provided with spare-time existence/nonexistence selection units 101 and 111, and setting units 103 and 113. Also, the network printer 200 is provided with a storage unit 210, a control unit 220, a printing unit 230, a real-time clock unit 240, a deletion unit 250, and a checking unit 260.

The spare-time existence/nonexistence selection units 101 and 111 enable a user to select whether to perform a printing of print data immediately or when the network printer 200 is in an idle state, in other words, if printing of the print data may be delayed and printed when other print data are not required to be printed.

The setting units 103 and 113 enable a user to set a print limit time with respect to the print data having time to spare or a window of time in which to print the print data such as five minutes, ten minutes and so on that is selected by the spare-time existence/nonexistence selection units 101 and 111.

Information about the time to spare and the print limit time, which are selected and set by the spare-time existence/nonexistence selection units 101 and 111 and the setting units 103 and 113, respectively, is transmitted to the network printer 200 together with the print data. Herein, the term “time to spare” refers to a user having the willingness to wait for their print data to be printed.

The storage unit 210 spools and stores the print data received from at least one of the hosts 100 and 110. Here, it is preferable that the storage unit 210 sequentially store the print data transmitted from the hosts 100 and 110 in a first in first out (FIFO) manner in order to spool and store the received print data.

The control unit 220 controls the printing unit 230 so that the print data having time to spare, which is selected by the spare-time existence/nonexistence selection units 101 and 111 from among the print data spooled and stored in the storage unit 210, is printed after the print data input subsequently without time to spare is first printed.

The real-time clock unit 240 tracks the present time. If the present time measured by the real-time clock unit 240 reaches the print limit time set by the setting units 103 and 113, the deletion unit 250 deletes the print data having time to spare that is stored in the storage unit 210. This is to prevent the print data from occupying the capacity of the storage unit 210 in a state that the present time exceeds the print limit time. However, instead of the deletion, the corresponding print data may be stored in a dedicated memory (not illustrated) in order to reset the existence/nonexistence of the time to spare and the print limit time at a later time.

The checking unit 260 checks whether the print data is stored in the storage unit 210 and whether the printing unit 230 is being driven. At this time, if it is determined that the printing unit 230 is not being driven, the checking unit 260 determines that the network printer 200 is in an idle state. If the printing unit 230 is in the idle state before the present time measured by the real-time clock unit 240 reaches the print limit time, and no other print data is stored in the storage unit 210 except for the print data having the time to spare, the control unit 220 controls the printing unit 230 to print the print data having time to spare.

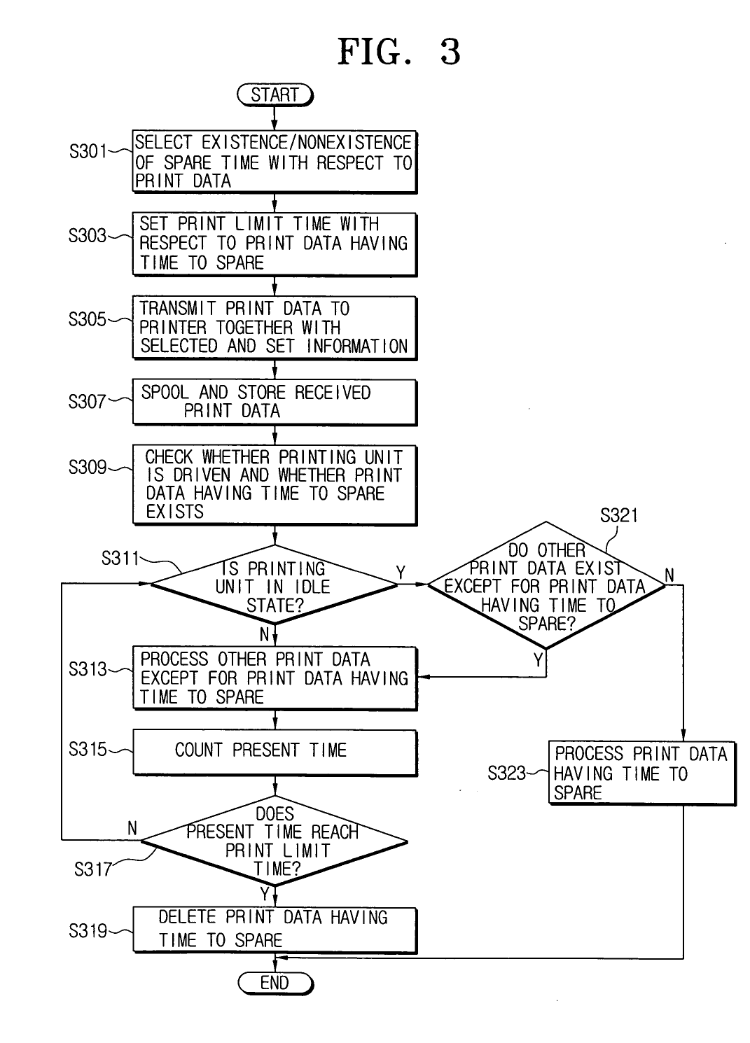

FIG. 3 is a flowchart illustrating a printing control method for the network printing system of FIG. 2. Referring to FIG. 3, the operation and effect of the network printing system according to an embodiment of the present invention will be explained in detail.

The user, who has prepared a document or image data through an application program installed in the hosts 100 and 110, selects whether there is time to spare with respect to the document or image data to be printed through the spare-time existence/nonexistence selection units 101 and 111 at step S301. At this time, if it is selected that the print data has time to spare, for example, does not have to be printed immediately, the user sets the print limit time with respect to the print data selected to have time to spare through the setting units 103 and 113 at step S303. Here, if it is selected that the print data has no time to spare by the spare-time existence/nonexistence selection units 101 and 111, the network printer 200 prints the corresponding print data in a FIFO manner.

Information selected and set by the spare-time existence/nonexistence selection units 101 and 111 and the setting units 103 and 113, respectively, is transmitted to the network printer 200 together with the print data at step S305.

The storage unit 210 of the network printer 200 spools and stores the print data received from at least one of the hosts 100 and 110 in the FIFO manner at step S307.

The checking unit 260 checks whether the print data having time to spare is stored in the storage unit 210 and whether the printing unit 230 is in an idle or non-printing state by checking the storage unit 210 and the printing unit 230 at step S309. At this time, if the printing unit 230 is not in an idle state at step S311, but the print data having time to spare exists in the storage unit 210, the control unit 220 controls the printing unit 230 so that the print data having time to spare from among the print data stored in the storage unit 210 is printed after other print data input subsequently is first printed at step S313.

Meanwhile, the real-time clock unit 240 tracks the present time at step S315. If the present time measured by the real-time clock unit 240 reaches the print limit time set by the setting units 103 and 113 at step S317, the deletion unit 250 deletes the print data having time to spare that is stored in the storage unit 210 at step S319.

If the printing unit 230 is in the idle state and no other print data is stored in the storage unit 210 except for the print data having time to spare at step S321, the control unit 220 controls the printing unit 230 to print the print data having time to spare that is stored in the storage unit 210 at step S323. At this time, if a plurality of print data having time to spare exist, it is preferable for the control unit 220 to control the printing unit 230 so that the print data having time to spare that are stored in the storage unit 210 are sequentially printed in the order of their time to spare, starting from the print data having the shortest time to spare.

As described above, the network printing system according to an embodiment of the present invention can prevent print jobs from being congested by enabling a user to select the existence/nonexistence of a spare time with respect to the prepared print data and printing the print data having time to spare when the network printer is in an idle state. Also, the network printing system according to an embodiment of the present invention sets a print limit time with respect to the print data having time to spare that is selected by the user, and properly handles the set print limit time, so as to prevent the storage unit from being overloaded with data.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations should be apparent to those skilled in the art.

1. A network printing system comprising:
a plurality of hosts for selecting a delay for print data and transmitting the selected information together with the print data; and
a network printer having a printing unit, a storage unit for spooling and storing the print data that is received from one of the plurality of hosts, and a control unit for controlling the printing unit so that the print data having the delay from among the print data that are stored in the storage unit is printed after the print data input subsequently is first printed.

2. The network printing system as claimed in claim 1, wherein the host includes a setting unit for setting a delay duration period with respect to the print data having the delay.

3. The network printing system as claimed in claim 2, wherein the network printer further comprises:
a real-time clock unit for tracking the present time; and
a deletion unit for deleting the print data having the delay that is stored in the storage unit if the present time reaches the delay duration period set by the setting unit.

4. The network printing system as claimed in claim 3, wherein the network printer further comprises a checking unit for determining whether the printing unit is being driven and whether the print data is stored in the storage unit,
wherein the control unit controls the printing unit to print the print data having the delay if it is determined that the printing unit is in an idle state before the present time reaches the delay duration period and no other print data that is stored in the storage unit exists except for the print data having the delay.

5. A printing control method for a network printing system in which plural hosts are connected to a network printer, the method comprising the steps of:
(a) one of the plurality of hosts selecting a delay for print data and transmitting the selected information to the network printer together with the print data;
(b) the network printer spooling and storing at least one of the received print data; and
(c) controlling the printing so that the print data having the delay from among the print data that are stored in the step (b) is printed after the print data input subsequently is first printed.

6. The printing control method as claimed in claim 5, wherein the step (a) includes the step of (d) setting a delay duration period with respect to the print data having the delay.

7. The printing control method as claimed in claim 6, further comprising the steps of:
(e) tracking the present time; and
(f) deleting the print data having the delay that is stored in the step (b) if the present time tracked in the step (e) reaches the delay duration period in the step (d).

8. The printing control method as claimed in claim 7, further comprising the step of:
(g) checking whether a printing unit is driven and whether the print data is stored in the step (b);
wherein the step (c) controls the printing unit to print the print data having the delay if it is determined that the printing unit is in an idle state before the present time reaches the delay duration period and no other stored print data exists except for the print data having the delay.

9. The printing control method as claimed in claim 8, wherein if a plurality of print data having the delay exist, the step (c) controls the printing unit to sequentially print the print data stored in the storage unit, starting from the print data having the shortest delay duration period.
